(19) United States
(12) Patent Application Publication
(10) Pub. No.: US 2024/0420679 A1
(43) Pub. Date: Dec. 19, 2024

(54) SYSTEM AND METHOD TO DISTRIBUTE INTERACTIVE MEDIA WITH LOW LATENCY FOR EFFICIENT CONTACT CENTER

(71) Applicant: NICE LTD., Ra’anana (IL)

(72) Inventors: Ankush JINDAL, Pune (IN); Bhagyashree BHOYAR, Pune (IN); Jitesh NEVE, Pune (IN); Pallav JOSHI, Ujjain (IN); Rohit AWALGAONKAR, Pune (IN); Salil DHAWAN, Pune (IN)

(21) Appl. No.: 18/336,482

(22) Filed: Jun. 16, 2023

(51) Int. Cl. G10L 13/08; G10L 15/00; G10L 15/04

(52) U.S. Cl. CPC G10L 13/086; G10L 15/005; G10L 15/04

(57) ABSTRACT

Translation and customer interaction distribution systems and methods, and non-transitory computer readable media, including receiving an audio interaction from a customer in a source language; identifying the source language from a portion of the audio interaction; dividing the portion of the audio interaction into frames by audio segmentation; converting the frames into text in the source language; translating the text in the source language to text in a target language of an agent; converting the text in the target language to speech in the target language; and providing the speech in the target language to the agent in real-time.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for translating and distributing customer interactions, and more particularly to methods and systems that divide an audio interaction into chunks or frames prior to translation to decrease processing time.

### BACKGROUND

Contact centers are people-centric organizations that consistently face challenges regarding staff or agent attendance. As a result, contact center leadership continually deals with a form of crisis management due to not having enough agents to handle incoming interactions. The source of the challenge may result in lower-than-expected staffing levels or higher-than-expected call volume.

One of the most critical issues in contact centers is to provide quick support to customers during peak hours or when a crisis happens, when a customer needs immediate support. Contact centers face challenges in providing support during these times, including longer than expected queue times, degraded customer experience, and increased load on contact centers.

Existing solutions include increasing agent manpower, but this comes with an additional cost to the contact centers, and the increase in agent count is utilized only during peak hours. Another possible solution is connecting a customer with an available agent across geographies, but the customer may face a language barrier and a huge latency.

Accordingly, there is a need for a solution that efficiently distributes interactions with low latency across geographies for optimal performance of contact centers that is more efficient that currently existing solutions.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a contact center according to various aspects of the present disclosure.

FIG. 2 is a more detailed block diagram of the contact center of FIG. 1 according to aspects of the present disclosure.

FIG. 3 is a simplified diagram of a data flow according to embodiments of the present disclosure.

FIG. 4 illustrates a “chunking” algorithm according to embodiments of the present disclosure.

FIG. 5 is a flowchart of a method according to embodiments of the present disclosure.

FIG. 6 illustrates a method of distributing an audio interaction according to embodiments of the present disclosure.

FIG. 7 illustrates a method of preparing parameters according to embodiments of the present disclosure.

FIG. 8 illustrates a method of calculating accuracy of a translation according to embodiments of the present disclosure.

FIG. 9 is a graph that shows lower processing times according to embodiments of the present disclosure.

FIG. 10 is an exemplary user interface for quality management according to embodiments of the present disclosure.

FIG. 11 is a block diagram of a computer system suitable for implementing one or more components in FIG. 1, FIG. 2, or FIG. 3 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods inherently reduce conversation latency in customer interactions, and make conversation more interactive in real-time, to provide a seamless customer experience. According to an exemplary embodiment, the language in which a customer is speaking is automatically detected or identified. When the customer starts speaking, the live streamlining data is analyzed and processed instead of waiting for a pause or for the customer to complete speaking. Each chunk or frame of the audio data is processed in parallel, and the result is obtained in a single, shorter processing time.

The present systems and methods leverage specific identifiers to break an interaction into small chunks or frames and then send them for immediate processing. Because smaller chunks or frames are translated little by little, the present systems and methods translate a sentence in less time compared to traditional methods. For example, a paragraph of 70-90 words generally takes about 15 seconds to process using traditional methods. In one embodiment, the processing time as disclosed herein is reduced to about 4-5 seconds to process the paragraph of 70-90 words. Moreover, the present systems and methods also ensure that there is a two-way translation that is separate for the agent and the customer. The threads are separated and are executed independently.

According to one or more embodiments, the algorithm used in the present systems and methods buffers bits of information, and processes them in parallel chunks to deliver them at the same time to the end user at an increased efficiency. This elegantly and efficiently decreases the processing time to about one-third that of existing solutions provide, while maintaining substantially similar or similar quality of the converted data. The reduced latency is achieved by breaking the interaction into small chunks or frames and subsequently processing each chunk or frame in parallel and in real-time. Advantageously, the present systems and methods ensure reduced contact center costs, increased efficiency, and a seamless customer experience.

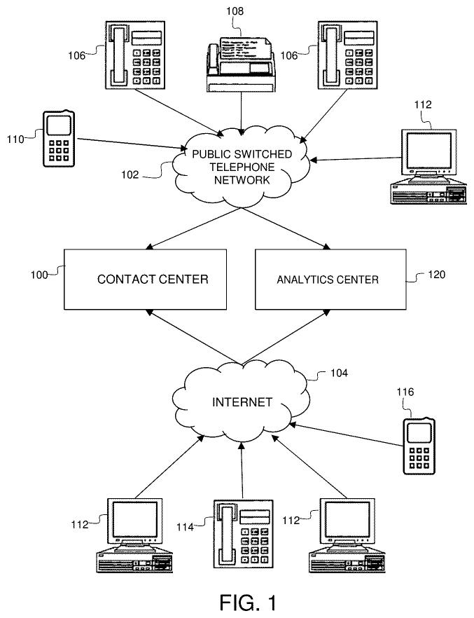

FIG. 1 is a simplified block diagram of an embodiment of a contact center 100 according to various aspects of the present disclosure. The term “contact center,” as used herein, can include any facility or system server suitable for receiving and recording electronic communications from contacts. Thus, it should be understood that the term “audio interaction” or “voice conversation” includes other forms of contact as described herein than merely a phone call. Such contact communications can include, for example, call interactions, chats, web interactions, voice over IP (“VoIP”) and video. Various specific types of communications contemplated through contact center channels include, without limitation, email, SMS data (e.g., text), tweet, instant message, web-form submission, smartphone app, social media data, and web content data (including but not limited to internet survey data, blog data, microblog data, discussion forum data, and chat data), etc. In some embodiments, the communications can include contact tasks, such as taking an order, making a sale, responding to a complaint, etc. In various aspects, real-time communication, such as voice, video, or both, is preferably included. It is contemplated that these communications may be transmitted by and through any type of telecommunication device and over any medium suitable for carrying data. For example, the communications may be transmitted by or through telephone lines, cable, or wireless communications. As shown in FIG. 1, the contact center 100 of the present disclosure is adapted to receive and record varying electronic communications and data formats that represent an interaction that may occur between a customer (or caller) and a contact center agent during fulfillment of a customer and agent transaction. In one embodiment, the contact center 100 records all of the customer interactions in uncompressed audio formats. In the illustrated embodiment, customers may communicate with agents associated with the contact center 100 via multiple different communication networks such as a public switched telephone network (PSTN) 102 or the Internet 104. For example, a customer may initiate an interaction session through traditional telephones 106, a fax machine 108, a cellular (i.e., mobile) telephone 110, a personal computing device 112 with a modem, or other legacy communication device via the PSTN 102. Further, the contact center 100 may accept internet-based interaction sessions from personal computing devices 112, VOIP telephones 114, and internet-enabled smartphones 116 and personal digital assistants (PDAs). Thus, in one embodiment, “call” means a voice interaction such as by traditional telephony or VoIP.

As one of ordinary skill in the art would recognize, the illustrated example of communication channels associated with a contact center 100 in FIG. 1 is just an example, and the contact center may accept customer interactions, and other analyzed interaction information and/or routing recommendations from an analytics center, through various additional and/or different devices and communication channels whether or not expressly described herein.

For example, in some embodiments, internet-based interactions and/or telephone-based interactions may be routed through an analytics center 120 before reaching the contact center 100 or may be routed simultaneously to the contact center and the analytics center (or even directly and only to the contact center, where analysis and processing as described herein can also be conducted). Also, in some embodiments, internet-based interactions may be received and handled by a marketing department associated with either the contact center 100 or analytics center 120. The analytics center 120 may be controlled by the same entity or a different entity than the contact center 100. Further, the analytics center 120 may be a part of, or independent of, the contact center 100.

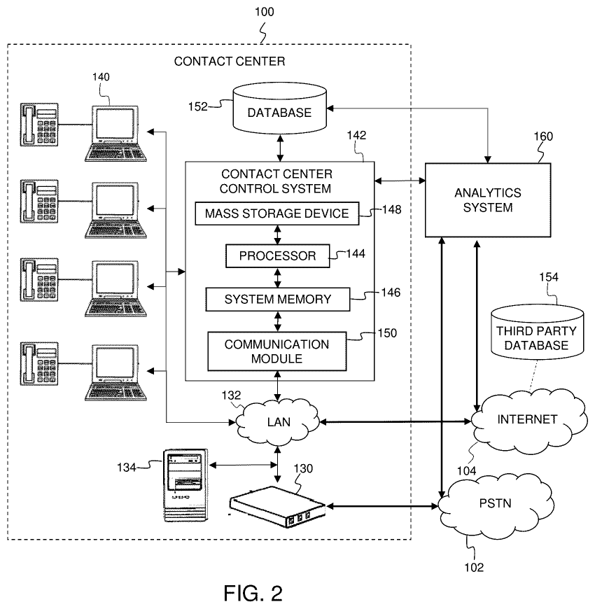

FIG. 2 is a more detailed block diagram of an embodiment of the contact center 100 according to aspects of the present disclosure. As shown in FIG. 2, the contact center 100 is communicatively coupled to the PSTN 102 via a distributed private branch exchange (PBX) switch 130 and/or ACD 130. The PBX switch 130 provides an interface between the PSTN 102 and a local area network (LAN) 132 within the contact center 100. In general, the PBX switch 130 connects trunk and line station interfaces of the PSTN 102 to components communicatively coupled to the LAN 132. The PBX switch 130 may be implemented with hardware or virtually. A hardware-based PBX may be implemented in equipment located local to the user of the PBX system. In contrast, a virtual PBX may be implemented in equipment located at a central telephone service provider that delivers PBX functionality as a service over the PSTN 102. Additionally, in one embodiment, the PBX switch 130 may be controlled by software stored on a telephony server 134 coupled to the PBX switch. In another embodiment, the PBX switch 130 may be integrated within telephony server 134. The telephony server 134 incorporates PBX control software to control the initiation and termination of connections between telephones within the contact center 100 and outside trunk connections to the PSTN 102. In addition, the software may monitor the status of all telephone stations coupled to the LAN 132 and may be capable of responding to telephony events to provide traditional telephone service. In certain embodiments, this may include the control and generation of the conventional signaling tones including without limitation dial tones, busy tones, ring back tones, as well as the connection and termination of media streams between telephones on the LAN 132. Further, the PBX control software may programmatically implement standard PBX functions such as the initiation and termination of telephone calls, either across the network or to outside trunk lines, the ability to put calls on hold, to transfer, park and pick up calls, to conference multiple callers, and to provide caller ID information. Telephony applications such as voice mail and auto attendant may be implemented by application software using the PBX as a network telephony services provider.

Often, in contact center environments such as contact center 100, it is desirable to facilitate routing of customer interactions, particularly based on agent availability, prediction of profile (e.g., personality type) of the customer occurring in association with a contact interaction, and/or matching of contact attributes to agent attributes, be it a telephone-based interaction, a web-based interaction, or other type of electronic interaction over the PSTN 102 or Internet 104. In various embodiments, ACD 130 is configured to route customer interactions to agents based on availability, profile, and/or attributes.

In one embodiment, the telephony server 134 includes a trunk interface that utilizes conventional telephony trunk transmission supervision and signaling protocols required to interface with the outside trunk circuits from the PSTN 102. The trunk lines carry various types of telephony signals such as transmission supervision and signaling, audio, fax, or modem data to provide plain old telephone service (POTS). In addition, the trunk lines may carry other communication formats such T1, ISDN or fiber service to provide telephony or multimedia data images, video, text or audio.

The telephony server 134 includes hardware and software components to interface with the LAN 132 of the contact center 100. In one embodiment, the LAN 132 may utilize IP telephony, which integrates audio and video stream control with legacy telephony functions and may be supported through the H.323 protocol. H.323 is an International Telecommunication Union (ITU) telecommunications protocol that defines a standard for providing voice and video services over data networks. H.323 permits users to make point-to-point audio and video phone calls over a local area network. IP telephony systems can be integrated with the public telephone system through an IP/PBX-PSTN gateway, thereby allowing a user to place telephone calls from an enabled computer. For example, a call from an IP telephony client within the contact center 100 to a conventional telephone outside of the contact center would be routed via the LAN 132 to the IP/PBX-PSTN gateway. The IP/PBX-PSTN gateway would then translate the H.323 protocol to conventional telephone protocol and route the call over the PSTN 102 to its destination. Conversely, an incoming call from a contact over the PSTN 102 may be routed to the IP/PBX-PSTN gateway, which translates the conventional telephone protocol to H.323 protocol so that it may be routed to a VoIP-enable phone or computer within the contact center 100.

The contact center 100 is further communicatively coupled to the Internet 104 via hardware and software components within the LAN 132. One of ordinary skill in the art would recognize that the LAN 132 and the connections between the contact center 100 and external networks such as the PSTN 102 and the Internet 104 as illustrated by FIG. 2 have been simplified for the sake of clarity and the contact center may include various additional and/or different software and hardware networking components such as routers, switches, gateways, network bridges, hubs, and legacy telephony equipment.

As shown in FIG. 2, the contact center 100 includes a plurality of agent workstations 140 that enable agents employed by the contact center 100 to engage in customer interactions over a plurality of communication channels. In one embodiment, each agent workstation 140 may include at least a telephone and a computer workstation. In other embodiments, each agent workstation 140 may include a computer workstation that provides both computing and telephony functionality. Through the workstations 140, the agents may engage in telephone conversations with the customer, respond to email inquiries, receive faxes, engage in instant message conversations, text (e.g., SMS, MMS), respond to website-based inquires, video chat with a customer, and otherwise participate in various customer interaction sessions across one or more channels including social media postings (e.g., Facebook, LinkedIn, Instagram, etc.). Further, in some embodiments, the agent workstations 140 may be remotely located from the contact center 100, for example, in another city, state, or country. Alternatively, in some embodiments, an agent may be a software-based application configured to interact in some manner with a customer. An exemplary software-based application as an agent is an online chat program designed to interpret customer inquiries and respond with pre-programmed answers.

The contact center 100 further includes a contact center control system 142 that is generally configured to provide recording, voice analysis, fraud detection analysis, behavioral analysis, text analysis, storage, and other processing functionality to the contact center 100. In the illustrated embodiment, the contact center control system 142 is an information handling system such as a computer, server, workstation, mainframe computer, or other suitable computing device. In other embodiments, the control system 142 may be a plurality of communicatively coupled computing devices coordinated to provide the above functionality for the contact center 100. The control system 142 includes a processor 144 that is communicatively coupled to a system memory 146, a mass storage device 148, and a communication module 150. The processor 144 can be any custom made or commercially available processor, a central processing unit (CPU), an auxiliary processor among several processors associated with the control system 142, a semiconductor-based microprocessor (in the form of a microchip or chip set), a microprocessor, a collection of communicatively coupled processors, or any device for executing software instructions. The system memory 146 provides the processor 144 with non-transitory, computer-readable storage to facilitate execution of computer instructions by the processor. Examples of system memory may include random access memory (RAM) devices such as dynamic RAM (DRAM), synchronous DRAM (SDRAM), solid state memory devices, and/or a variety of other memory devices known in the art. Computer programs, instructions, and data, such as voice prints, may be stored on the mass storage device 148. Examples of mass storage devices may include hard discs, optical disks, magneto-optical discs, solid-state storage devices, tape drives, CD-ROM drives, and/or a variety other mass storage devices known in the art. Further, the mass storage device may be implemented across one or more network-based storage systems, such as a storage area network (SAN). The communication module 150 is operable to receive and transmit contact center-related data between local and remote networked systems and communicate information such as contact interaction recordings between the other components coupled to the LAN 132. Examples of communication modules may include Ethernet cards, 802.11 WiFi devices, cellular data radios, and/or other suitable devices known in the art. The contact center control system 142 may further include any number of additional components, which are omitted for simplicity, such as input and/or output (I/O) devices (or peripherals), buses, dedicated graphics controllers, storage controllers, buffers (caches), and drivers. Further, functionality described in association with the control system 142 may be implemented in software (e.g., computer instructions), hardware (e.g., discrete logic circuits, application specific integrated circuit (ASIC) gates, programmable gate arrays, field programmable gate arrays (FPGAs), etc.), or a combination of hardware and software.

According to one aspect of the present disclosure, the contact center control system 142 is configured to record, collect, and analyze customer voice data and other structured and unstructured data, and other tools may be used in association therewith to increase efficiency and efficacy of the contact center. As an aspect of this, the control system 142 is operable to record unstructured interactions between customers and agents occurring over different communication channels including without limitation call interactions, email exchanges, website postings, social media communications, smartphone application (i.e., app) communications, fax messages, texts (e.g., SMS, MMS, etc.), and instant message conversations. An unstructured interaction is defined herein as a voice interaction between two persons (e.g., between an agent of the contact center 100 such as call center personnel or a chatbot, and a caller of the contact center 100, etc.) that include phrases that are not predetermined prior to the voice interaction. An example of an unstructured interaction may include the agent asking the caller “what can I help you with today,” to which the caller may answer with any possible answers. By contrast, a structured interaction is defined as a sequence of phrases between the two persons that are predetermined prior to the voice interaction. An example structured interaction may include the agent asking the caller “are you looking to change an address or withdraw money today,” to which the caller may only be able to answer based on any one of the two predetermined phrases-“change an address” or “withdraw money.”

The control system 142 may include a hardware or software-based recording server to capture the audio of a standard or VoIP telephone connection established between an agent workstation 140 and an outside contact telephone system. Further, the audio from an unstructured telephone call or video conference session (or any other communication channel involving audio or video, e.g., a Skype call) may be transcribed manually or automatically and stored in association with the original audio or video. In one embodiment, multiple communication channels (i.e., multi-channel) may be used, either in real-time to collect information, for evaluation, or both. For example, control system 142 can receive, evaluate, and store telephone calls, emails, and fax messages. Thus, multi-channel can refer to multiple channels of interaction data, or analysis using two or more channels, depending on the context herein.

In addition to unstructured interaction data such as interaction transcriptions, the control system 142 is configured to captured structured data related to customers, agents, and their interactions. For example, in one embodiment, a “cradle-to-grave” recording may be used to record all information related to a particular telephone call from the time the call enters the contact center to the later of: the caller hanging up or the agent completing the transaction. All or a portion of the interactions during the call may be recorded, including interaction with an IVR system, time spent on hold, data keyed through the caller's keypad, conversations with the agent, and screens displayed by the agent at his/her station during the transaction. Additionally, structured data associated with interactions with specific customers may be collected and associated with each customer, including without limitation the number and length of calls placed to the contact center, call origination information, reasons for interactions, outcome of interactions, average hold time, agent actions during interactions with the customer, manager escalations during calls, types of social media interactions, number of distress events during interactions, survey results, and other interaction information, or any combination thereof. In addition to collecting interaction data associated with a customer, the control system 142 is also operable to collect biographical profile information specific to a customer including without limitation customer phone number, account/policy numbers, address, employment status, income, gender, race, age, education, nationality, ethnicity, marital status, credit score, contact “value” data (i.e., customer tenure, money spent as customer, etc.), personality type (as determined based on past interactions), and other relevant customer identification and biological information, or any combination thereof. The control system 142 may also collect agent-specific unstructured and structured data including without limitation agent personality type, gender, language skills, technical skills, performance data (e.g., customer retention rate, etc.), tenure and salary data, training level, average hold time during interactions, manager escalations, agent workstation utilization, and any other agent data relevant to contact center performance, or any combination thereof. Additionally, one of ordinary skill in the art would recognize that the types of data collected by the contact center control system 142 that are identified above are simply examples and additional and/or different interaction data, customer data, agent data, and telephony data may be collected and processed by the control system 142.

The control system 142 may store recorded and collected interaction data in a database 152, including customer data and agent data. In certain embodiments, agent data, such as agent scores for dealing with customers, are updated daily or at the end of an agent shift.

The control system 142 may store recorded and collected interaction data in a database 152. The database 152 may be any type of reliable storage solution such as a RAID-based storage server, an array of hard disks, a storage area network of interconnected storage devices, an array of tape drives, or some other scalable storage solution located either within the contact center or remotely located (i.e., in the cloud). Further, in other embodiments, the contact center control system 142 may have access not only to data collected within the contact center 100 but also data made available by external sources such as a third party database 154. In certain embodiments, the control system 142 may query the third party database for contact data such as credit reports, past transaction data, and other structured and unstructured data.

Additionally, in some embodiments, an analytics system 160 may also perform some or all of the functionality ascribed to the contact center control system 142 above. For instance, the analytics system 160 may record telephone and internet-based interactions, convert discussion to text (e.g., for linguistic analysis or text-dependent searching) and/or perform behavioral analyses. The analytics system 160 may be integrated into the contact center control system 142 as a hardware or software module and share its computing resources 144, 146, 148, and 150, or it may be a separate computing system housed, for example, in the analytics center 120 shown in FIG. 1. In the latter case, the analytics system 160 includes its own processor and non-transitory computer-readable storage medium (e.g., system memory, hard drive, etc.) on which to store analytics software and other software instructions.

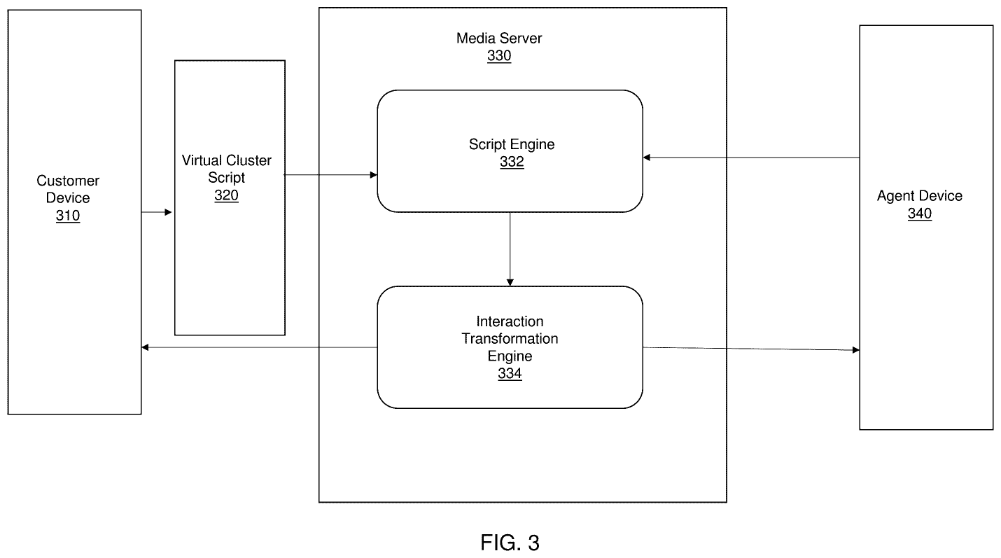

FIG. 3 illustrates a system flow for an audio interaction or a voice conversation according to embodiments of the present disclosure. A customer contacts the contact center using a customer device 310 to resolve his/her issues. The customer can be in any geographic region and speak any language. The audio interaction is passed to virtual cluster (VC) script 320, which provides all metadata required for routing the audio interaction to a specific agent. In one or more embodiments, when a customer initiates the audio interaction, VC script 320 provides the configuration, which includes the available agents (e.g., which in all cases throughout this disclosure, the term “agents” means one or more agents), the status of the agents, the geographical region where the agents are available, and the languages the agents speak. VC script 320 is responsible for providing information about which languages a particular agent supports and in which geographic region the agent is located.

Media server 330 includes script engine 332 and interaction transformation engine 334. Once the audio interaction comes to media server 330, script engine 332 first detects the language of the customer and checks VC script 320 to determine if there is any agent with the required skill and language. If there is an agent available, then the audio interaction is routed to that agent. If no agent is available, script engine 332 continues to try to find an available agent until a defined threshold waiting time is exceeded. If there are no agents available that speak the same language as the customer and have the required skill, then script engine 332 starts looking for an agent having the required skill with any language. If an agent is found with the required skill but a different language, then the audio interaction is provided to interaction transformation engine 334. Interaction transformation engine 334 works in a bi-directional way. Interaction transformation engine 334 breaks the voice message into chunks or frames and transforms the chunks or frames in parallel into the agent's language. Interaction transformation engine 334 works the same way when the agent speaks. The engine 334 breaks the agent's voice message into chunks or frames and transforms the chunks or frames in parallel into the customer's language.

In various embodiments, script engine 332 plays a significant role in identifying the language in which the customer is communicating, and it will start queuing the audio bytes. Depending on the language of the customer, script engine 332 passes these audio bytes in chunks or frames to interaction transformation engine 334 for further processing. Interaction transformation engine 334 then sends the communication to agents in their geographical languages.

Once script engine 332 identifies the language of the audio stream, audio processing by a variety of programming languages can be used to break the audio down into smaller chunks or frames. This can be accomplished by using audio segmentation, which involves dividing an audio signal into smaller, discrete parts based on certain characteristics of the signal (such as amplitude, frequency, or spectral content).

In one or more embodiments, script engine 332 identifies the response and language coming from the agents and in the same way as with the customers, it starts queuing the audio bytes and passes the interactions to interaction transformation engine 334 in chunks or frames and sends those to the customer device 310. In this way, script engine 332 identifies different languages within an audio stream and then converts the languages into smaller chunks or frames for more efficient transmission.

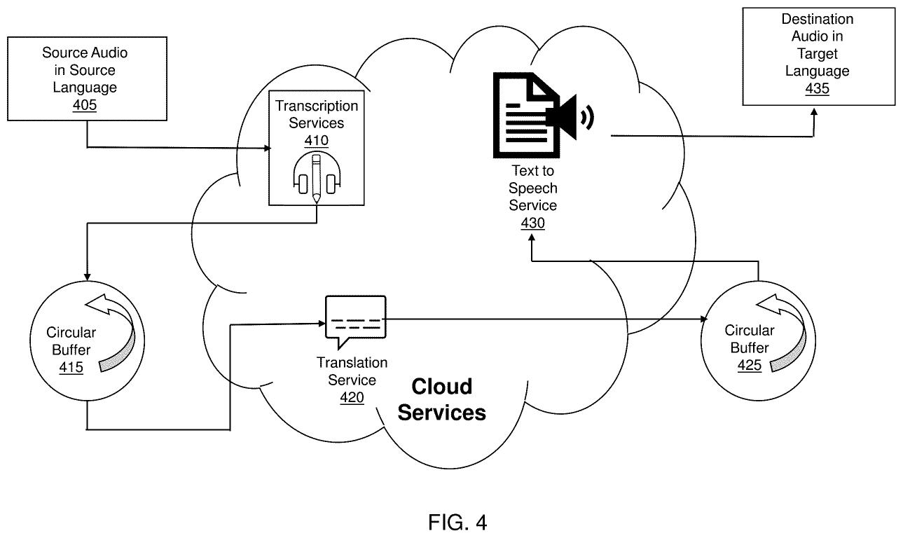

FIG. 4 illustrates the “chunking” algorithm according to embodiments of the present disclosure. As soon as source audio in the source language 405 is received, the source audio is sent to a transcription (cloud) service 410, which is responsible for converting the source audio into text. In one embodiment, after about 400 milliseconds after a word is spoken, the word is sent to the transcription service 410 to ensure the quality of the translation. In an exemplary embodiment, the source audio 405 is sent at a frequency of twice per second.

To identify the source language of the source audio 405, there are multiple language services that can be used. Below is a code snippet that uses Microsoft Cognitive Services Speech Software Development Kit (SDK) to identify the language.

```
using Microsoft.CognitiveServices.Speech;
using Microsoft.CognitiveServices.Speech.Audio;
public async Task <string> RecognizeLanguageAsync (string
audioFilePath)
{
  var config = SpeechConfig.FromSubscription(“your-subscription-key”,
  “your-service-region”)
  var audioConfig = AudioConfig.FromWavFileInput (audioFilePath);
  var recognizer = new SpeechRecognizer (config, audioConfig);
  var result = await recognizer.RecognizeOnceAsync ( );
  return result .Language ;
}
```

In this code, a SpeechRecognizer object is created that uses the audio file specified by audiofilePath. The RecognizeOnceAsync method is called to recognize speech in the audio and obtain a SpeechRecognitionResult object. The Language property of this object contains the identified language.

According to various embodiments, there are several algorithms that can be used to identify natural breakpoints in audio data. For example, energy-based segmentation uses the energy of the audio signal to detect changes in the sound. It works by dividing the audio into small frames, calculating the energy of each frame, and then identifying frames where the energy level is significantly higher or lower than surrounding frames. These frames can be used as breakpoints to segment the audio into smaller chunks.

Silence-based segmentation identifies periods of silence in the audio data and uses them as breakpoints. It works by dividing the audio into small frames and calculating the amplitude of each frame. If the amplitude falls below a certain threshold for a certain amount of time, the algorithm considers that period as silence and uses it as a breakpoint.

Waveform-based segmentation looks for changes in the waveform of the audio data to identify natural breakpoints. It works by dividing the audio into small frames and calculating the average waveform of each frame. If the waveform of a frame is significantly different from the surrounding frames, it can be used as a breakpoint, i.e., a pause in the audio data.

Once the audio interaction is broken down into frames, the frames are passed to transcription services 410. Transcription services 410 are services that convert audio into written text. These services can be useful for a variety of purposes. In the present disclosure, the transcription services 410 are used to transcribe audio chunks or frames to text. There are many transcription services 410 available online, ranging from fully automated software solutions to human-powered services that provide accurate and high-quality transcriptions.

Below is a code snippet using Microsoft Cognitive Services Speech SDK to obtain the transcription.

```
using Microsoft.CognitiveServices.Speech;
using Microsoft.CognitiveServices.Speech.Audio;
public async Task<string> TranscribeAudioToTextAsync (string
audioFilePath)
{
  var config = SpeechConfig.FromSubscription (“your-subscription-key”,
  “your-service-region”);
  var audioConfig = AudioConfig.FromWavFileInput (audioFilePath);
  var recognizer = new SpeechRecognizer (config, audioConfig);
  var result = await recognizer.RecognizeOnceAsync ( );
  return result.Text;
}
```

In certain embodiments, the transcription service data is stored in a circular buffer 415 (CB1). A circular buffer, also known as a circular queue or ring buffer, is a data structure that uses a fixed-size buffer to store data. The buffer is treated as a circular array, which means that when the end of the buffer is reached, the next data element is stored at the beginning of the buffer, effectively creating a loop.

The circular buffer is a memory block having two heads for reading and writing, which run in the same direction. The read head of CB1 415 reads and clears all data once it detects a pause and sends it for further processing in a separate thread to the translation service 420, where the source language text is translated to the target language text.

Another circular buffer 425 (CB2) works in the same manner for processing the output of the translation service 420. The read head of CB2 425 is triggered by a bit pause in the speech. In some embodiments, a bit pause can be a comma or a period that indicates there is a pause in the information being transmitted.

CB2 425 sends the translated text to a text to speech service 430, which converts the written text to audio. From there, the audio in the target language 435 is sent to its destination.

The advantage of a circular buffer is that it can be used to implement a queue or a stack with a fixed size, without needing to shift elements around when new elements are added or removed. This can make it a more efficient choice for certain types of applications, such as audio processing or real-time data acquisition.

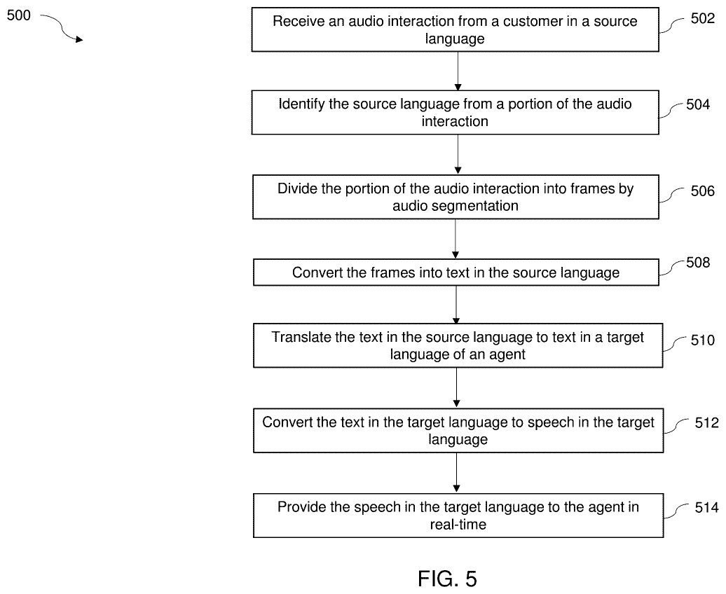

Referring now to FIG. 5, a method 500 according to various embodiments of the present disclosure is described. At step 502, contact center 100 receives an audio interaction or voice conversation (e.g., a call or other voice interaction) from customer device 310 in a source language.

At step 504, script engine 332 identifies the source language from a portion of the audio language. The portion can be an initial part of the first sentence spoken in the source language, an entire sentence, multiple sentences, or a paragraph.

At step 506, interaction transformation engine 334 divides the portion of the audio interaction into chunks or frames by audio segmentation. In various embodiments, the audio segmentation includes an energy-based segmentation, a silence-based segmentation, or a waveform based segmentation, as discussed above. Below are examples of how sentences may be split into chunks or frames.

In this example, the interaction is split by delimiter marks, such as a period, a comma, or a question mark. In some embodiments, the delimiter marks are provided by the transcription service itself when converting the speech to text.

Another possible identifier on where to split sentences is a small pause in the sentences.

At step 508, interaction transformation engine 334 converts the frames into text in the source language. In certain embodiments, the text in the source language is stored in a first circular buffer before translation of the text in the source language to the text in the target language. In one or more embodiments, the text is stored in the first circular buffer until the first circular buffer detects a punctuation mark, such as a period, a comma, or a question mark.

At step 510, interaction transformation engine 334 translates the text in the source language to text in a target language of an agent. In various embodiments, the text in the target language is stored in a second circular buffer before conversion of the text in the target language to the speech in the target language. In several embodiments, the text in the target language is stored in the second circular buffer until the second circular buffer detects a bit pause.

At step 512, interaction transformation engine 334 converts the text in the target language to speech in the target language.

At step 514, interaction transformation engine 334 provides the speech in the target language in real-time to the agent device 340.

In various embodiments, the contact center 100 receives an audio response in the target language from the agent device 340, script engine 332 identifies the target language from a portion of the audio response, interaction transformation engine 334 divides the portion of the audio response into chunks or frames by audio segmentation, interaction transformation engine 334 converts the frames into text in the target language, interaction transformation engine 334 translates the text in the target language to text in the source language, interaction transformation engine 334 converts the text in the source language to speech in the source, and interaction transformation engine 334 provides the speech in the source language to the customer device 310. In other words, method 500 can be implemented with respect to the agent's audio response to the customer.

In some embodiments, the method 500 further includes determining that an agent speaking the source language is not available and determining that a threshold waiting time for the customer is exceeded.

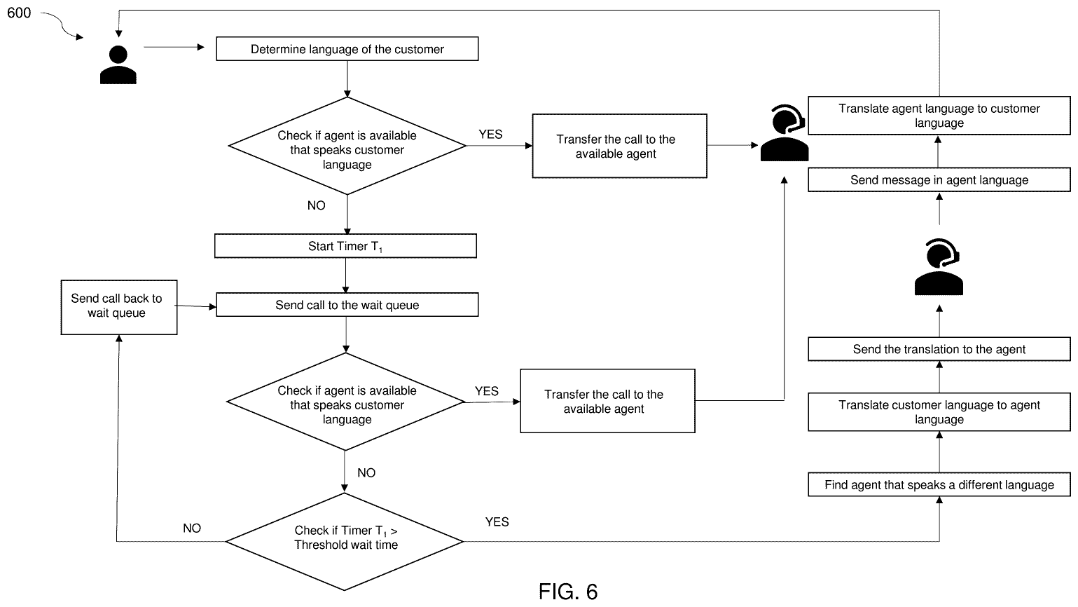

FIG. 6 illustrates an exemplary method 600 of distributing an audio interaction to agents in different locations who speak a different language than a customer according to embodiments of the present disclosure. After the source language (or language of the customer) is determined, interaction distribution engine 334 checks to see if an agent is available that speaks the customer language. If an agent is available that can speak the customer language and has the requisite skills, the audio interaction is transferred to the available agent.

If no agent is available, then a timer is started and the audio interaction is sent to the queue. Interaction distribution engine 334 once again checks to see if an agent is available that can speak the customer language. If so, the audio interaction is transferred to the agent. If not, the timer is checked to see if the threshold waiting time is exceeded. If the threshold waiting time has not yet been exceeded, the audio interaction is sent back to queue.

If the threshold waiting time has been exceeded, then interaction transformation engine 334 finds an agent that speaks a different language, the speech in the customer language is translated to the agent language, and the translation is sent to the agent. The agent's response is translated to the customer language, and then sent to the customer.

In various embodiments, the method 500 further includes determining a quality of the translation in the source language to the target language. Advantageously, the present systems and methods ensure that the quality of the translation is maintained as part of the execution of the algorithm. This is achieved via leveraging specific identifiers to ensure quality is not affected while translating and delivering to a receiver.

In several embodiments, the text in the target language that is generated is converted back into the source language, and the results compared with the original text in the source language. In some embodiments, the CalculateSimilarityIndex is leveraged to quantify the quality of the translation. The below illustrates the code block to calculate accuracy.

public static decimal CalculateSimilarityIndex(string source, string
destination)
{

| \| | decimal d; | |
|---|---|---|
| \| | int match = 0; | |
| \| | source = source.ToLower( ); | |
| \| | var q = destination.Split(‘ ’); | |
| \| | foreach (var el in q) | |
| \| | { | |
| \| | \| | if (source.Contains(el.ToLower( ))) |
| \| | \| | { |
| \| | \| | \| match++; |
| \| | \| | } |

| | |
|---|---|
| \| | } |
| \| | d = (decimal)match / q.Length * 100; |
| \| | AdjustPrecision(ref d); |
| \| | return d; |

}

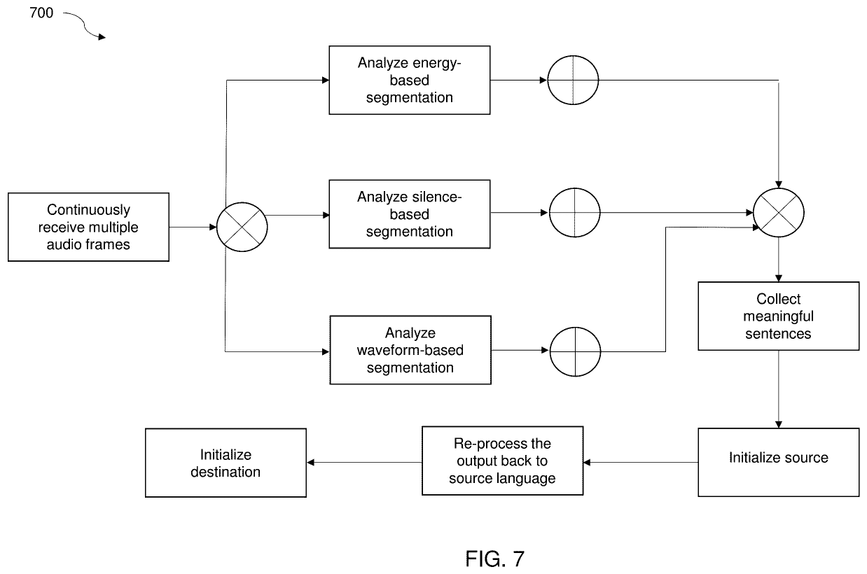

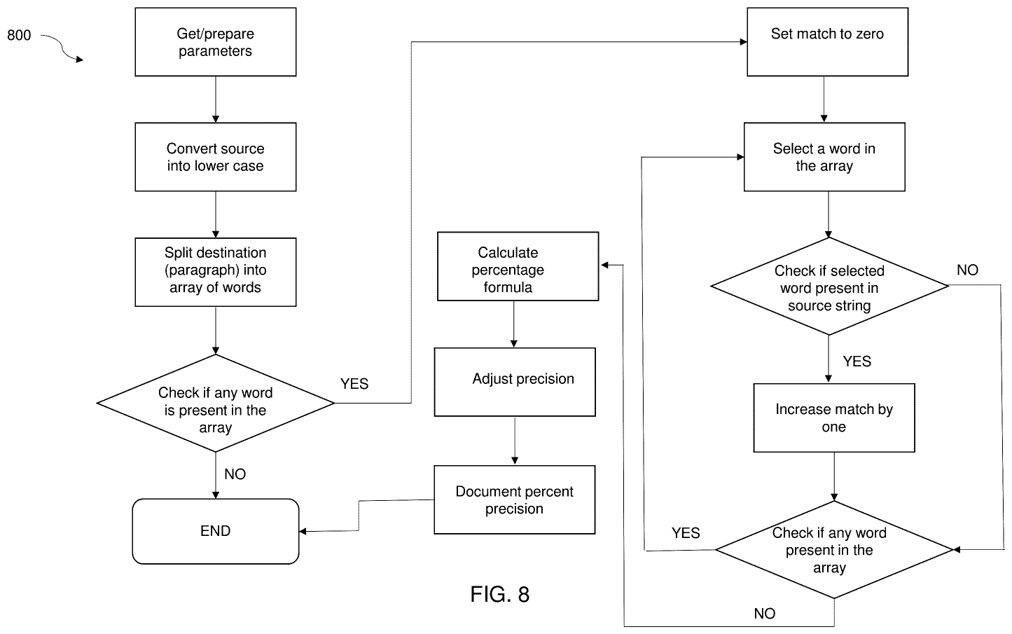

FIG. 7 illustrates a method 700 of preparing parameters that is used in the calculation of the accuracy of translations in FIG. 8. As shown, multiple audio frames are received continuously, and different modes of audio segmentation are analyzed. Meaningful sentences are collected, and the text in the source language is translated into the target language. The text in the target language is reprocessed back into the source language in the destination variable to form the destination string.

Referring to FIG. 8, the method 800 shows that the destination string from FIG. 7 is converted into lower case. The destination string is then split into words, and words in the source string (original text in the source language) and destination string are matched. Based on the similarity, the match in percentage is calculated In one embodiment, the formula used is (matched words/number of words in the string)*100. The precision is then adjusted up to two decimal places.

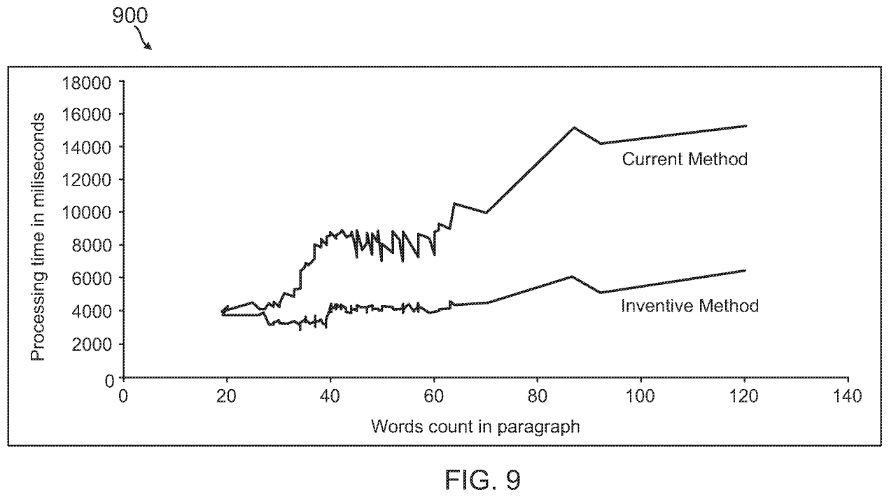

With reference to FIG. 9, the graph 900 illustrates how existing methods have a much longer processing time than the presently described methods. In the example of FIG. 9, the overall accuracy score of the translation was calculated to be 98.89. As shown, the time taken by the present methods is on a consistently lower trend as compared to the existing methods.

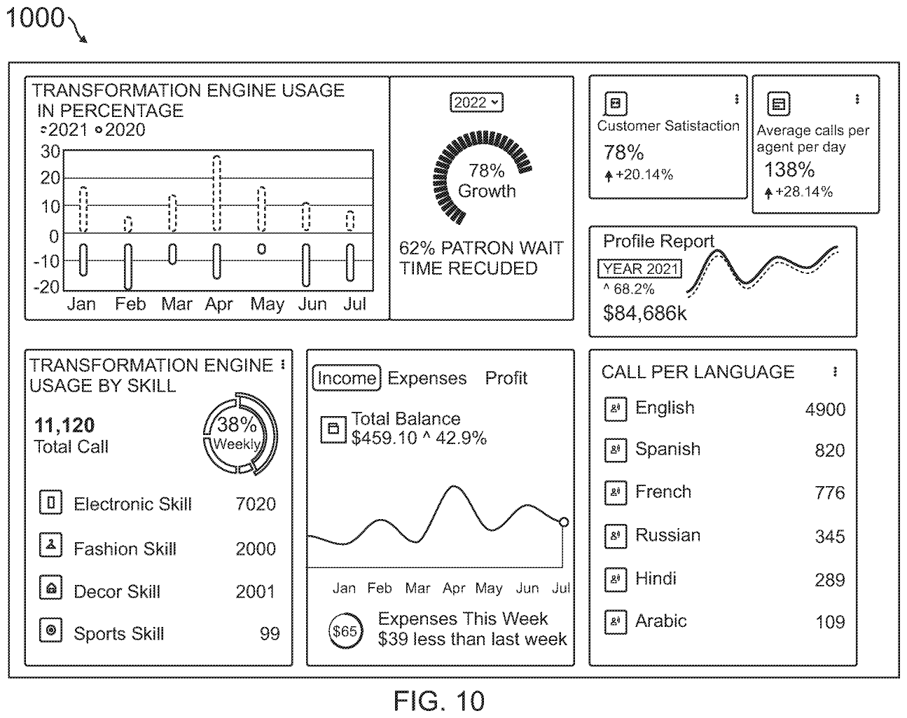

FIG. 10 shows an analytic dashboard 1000, which provides details about the ongoing calls of the agent and the customer. The first section called the “Transformation Engine Usage in Percentage” monitors the average wait time of the customer per year. Typically, the wait time is on the higher side as customers are usually waiting for local agents to serve instead of utilizing overseas agents. Utilization of interaction transformation engine 334 in the “Transformation Engine Usage by Skill” section can be monitored. This section shows the duration (e.g., weekly or monthly) utilization against skill (e.g., electronic, décor, sports, or fashion). In the bottom right corner, the number of “Calls per language” is monitored. The velocity of the contact center i.e., “Average calls per agent per day” is monitored on the top right. The dashboard 1000 also distinguishes the most important things like “profile report” and “customer satisfaction percentage.” The automated dashboard 1000 helps the contact center take corrective action and/or preventative actions if the numbers in the dashboard 1000 are going above or below the threshold.

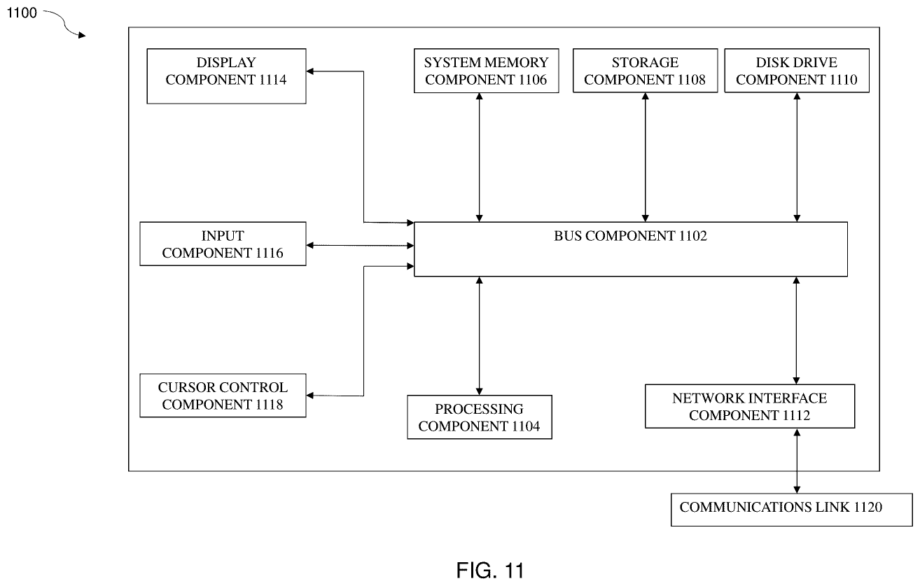

Referring now to FIG. 11, illustrated is a block diagram of a system 1100 suitable for implementing embodiments of the present disclosure. System 1100, such as part of a computer and/or a network server, includes a bus 1102 or other communication mechanism for communicating information, which interconnects subsystems and components, including one or more of a processing component 1104 (e.g., processor, micro-controller, digital signal processor (DSP), etc.), a system memory component 1106 (e.g., RAM), a static storage component 1108 (e.g., ROM), a network interface component 1112, a display component 1114 (or alternatively, an interface to an external display), an input component 1116 (e.g., keypad or keyboard), and a cursor control component 1118 (e.g., a mouse pad).

In accordance with embodiments of the present disclosure, system 1100 performs specific operations by processor 1104 executing one or more sequences of one or more instructions contained in system memory component 1106. Such instructions may be read into system memory component 1106 from another computer readable medium, such as static storage component 1108. These may include instructions to receive an audio interaction from a customer in a source language; identify the source language from a portion of the audio interaction; divide the portion of the audio interaction into frames by audio segmentation; convert the frames into text in the source language; translate the text in the source language to text in a target language of an agent; convert the text in the target language to speech in the target language; and provide the speech in the target language to the agent in real-time. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 1104 for execution. Such a medium may take many forms, including but not limited to, non-volatile media, volatile media, and transmission media. In various implementations, volatile media includes dynamic memory, such as system memory component 1106, and transmission media includes coaxial cables, copper wire, and fiber optics, including wires that comprise bus 1102. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 1100. In various other embodiments, a plurality of systems 1100 coupled by communication link 1120 (e.g., LAN, WLAN, PTSN, or various other wired or wireless networks) may perform instruction sequences to practice the disclosure in coordination with one another. Computer system 1100 may transmit and receive messages, data, information and instructions, including one or more programs (i.e., application code) through communication link 1120 and communication interface 1112. Received program code may be executed by processor 1104 as received and/or stored in disk drive component 1110 or some other non-volatile storage component for execution.

The Abstract at the end of this disclosure is provided to comply with 37 C.F.R. § 1.72 (b) to allow a quick determination of the nature of the technical disclosure. It is submitted with the understanding that it will not be used to interpret or limit the scope or meaning of the claims.

What is claimed is:

1. A translation and customer interaction distribution system comprising:
a processor and a computer readable medium operably coupled thereto, the computer readable medium comprising a plurality of instructions stored in association therewith that are accessible to, and executable by, the processor, to perform operations which comprise:
receiving an audio interaction from a customer in a source language;
identifying the source language from a portion of the audio interaction;
dividing the portion of the audio interaction into frames by audio segmentation;
converting the frames into text in the source language;
translating the text in the source language to text in a target language of an agent;
converting the text in the target language to speech in the target language; and
providing the speech in the target language to the agent in real-time.

2. The translation and customer interaction distribution system of claim 1, wherein the operations further comprise:
receiving an audio response in the target language from the agent;
identifying the target language from a portion of the audio response;
dividing the portion of the audio response into frames by audio segmentation;
converting the frames into text in the target language;
translating the text in the target language to text in the source language;
converting the text in the source language to speech in the source language; and
providing the speech in the source language to the customer in real-time.

3. The translation and customer interaction distribution system of claim 1, wherein the audio segmentation comprises an energy-based segmentation, a silence-based segmentation, or a waveform based segmentation.

4. The translation and customer interaction distribution system of claim 1, wherein the operations further comprise determining a quality of the translation in the source language to the target language.

5. The translation and customer interaction distribution system of claim 1, wherein the operations further comprising storing the text in the source language in a first circular buffer before translation of the text in the source language to the text in the target language.

6. The translation and interaction distribution system of claim 5, wherein the text in the source language is stored in the first circular buffer until the first circular buffer detects a punctuation mark.

7. The translation and customer interaction distribution system of claim 5, wherein the operations further comprise storing the text in the target language in a second circular buffer before conversion of the text in the target language to the speech in the target language.

8. The translation and customer interaction distribution system of claim 7, wherein the text in the target language is stored in the second circular buffer until the second circular buffer detects a bit pause.

9. The translation and customer interaction distribution system of claim 1, wherein the operations further comprise:
determining that an agent speaking the source language is not available; and
determining that a threshold waiting time for the customer is exceeded.

10. A method for translating and distributing customer interactions, which comprises:
receiving an audio interaction from a customer in a source language;
identifying the source language from a portion of the audio interaction;
dividing the portion of the audio interaction into frames by audio segmentation;
converting the frames into text in the source language;
translating the text in the source language to text in a target language of an agent;
converting the text in the target language to speech in the target language; and
providing the speech in the target language to the agent in real-time.

11. The method of claim 10, further comprising:
receiving an audio response in the target language from the agent;
identifying the target language from a portion of the audio response;
dividing the portion of the audio response into frames by audio segmentation;
converting the frames into text in the target language;
translating the text in the target language to text in the source language;
converting the text in the source language to speech in the source language; and
providing the speech in the source language to the customer in real-time.

12. The method of claim 10, wherein the audio segmentation comprises an energy-based segmentation, a silence-based segmentation, or a waveform based segmentation.

13. The method of claim 10, which further comprises determining a quality of the translation in the source language to the target language.

14. The method of claim 10, which further comprises storing the text in the source language in a first circular buffer before translation of the text in the source language to text in the target language.

15. The method of claim 14, which further comprises storing the text in the target language in a second circular buffer before conversion of the text in the target language to speech in the target language.

16. A non-transitory computer-readable medium having stored thereon computer-readable instructions executable by a processor to perform operations which comprise:
receiving an audio interaction from a customer in a source language;
identifying the source language from a portion of the audio interaction;
dividing the portion of the audio interaction into frames by audio segmentation;
converting the frames into text in the source language;
translating the text in the source language to text in a target language of an agent;
converting the text in the target language to speech in the target language; and
providing the speech in the target language to the agent in real-time.

17. The non-transitory computer-readable medium of claim 16, wherein the operations further comprise:
receiving an audio response in the target language from the agent;
identifying the target language from a portion of the audio response;
dividing the portion of the audio response into frames by audio segmentation;
converting the frames into text in the target language;
translating the text in the target language to text in the source language;
converting the text in the source language to speech in the source language; and
providing the speech in the source language to the customer in real-time.

18. The non-transitory computer-readable medium of claim 16, wherein the audio segmentation comprises an energy-based segmentation, a silence-based segmentation, or a waveform based segmentation.

19. The non-transitory computer-readable medium of claim 16, wherein the operations further comprise determining a quality of the translation in the source language to the target language.

20. The non-transitory computer-readable medium of claim 16, wherein the operations further comprise:
storing the text in the source language in a first circular buffer before translation of the text in the source language to text in the target language; and
storing the text in the target language in a second circular buffer before conversion of the text in the target language to speech in the target language.
